(19) United States
(12) Patent Application Publication
(10) Pub. No.: US 2009/0161624 A1
(43) Pub. Date: Jun. 25, 2009

(54) REGISTERING A MOBILE COMMUNICATION DEVICE WITH AN ACCESS NETWORK

(75) Inventors: Lloyd J. Johnson, Scottsdale, AZ (US); Craig P. Reilly, Bartlett, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/959,728

(22) Filed: Dec. 19, 2007

(51) Int. Cl. H04Q 7/00; H04L 9/32

(52) U.S. Cl. 370/331; 726/3

(57) ABSTRACT

A method (500, 600, 700) of registering a mobile communication device (102, 104, 106, 108) with an access network (112) can include receiving a request for a client mobile internet protocol (IP) registration from the mobile communication device. The method can also include performing a proxy mobile IP registration on behalf of the mobile communication device and sending a confirmation of the client mobile IP registration to the mobile communication device.

### BACKGROUND OF THE INVENTION

1. Field of the Invention

The present invention generally relates to mobile communications and, more particularly, to registering a mobile communication device with an access network.

2. Background of the Invention

A packet based mobile communication device (hereinafter “communication device”) typically is assigned a home Internet Protocol (IP) address, which typically includes a network identifier as well as a host identifier. Data packets being communicated to the communication device typically are first directed to the communication device's home access network using the network identifier, and then to the communication device using the host identifier. When the communication device roams to another access network, either client mobile IP or proxy mobile IP can be used to forward data to the communication device.

Client mobile IP (client mobile IPv4) is a protocol that establishes a tunnel, which is a secure communication channel, between the communication device and its home access network. When a communication device attempts network entry onto a foreign access network, a foreign agent associated with the access point typically issues a care-of-address to the communication device. The care-of-address is a unique IP address that the communication device may use as its endpoint of the tunnel. The communication device then may request a client mobile IP registration by sending a request to the foreign agent. The request can include the care-of-address and the home address of the communication device. The foreign agent can forward the request to the communication device's home agent. The home agent then may use the care-of-address to communicate a confirmation of the client mobile IP registration to the communication device and establish the tunnel between the home network and the communication device.

Proxy mobile IP is not a standard protocol under IPv4. Rather, proxy mobile IP is a class of protocols in which a network entity performs a mobile IP registration on behalf of a communication device. In proxy mobile IP, a foreign agent typically requests a proxy mobile IP registration with the home agent upon the communication device forming a communication link with an access point. The foreign agent can either provide its own IP address to the home agent as a proxy care-of-address or provide an IP address of a proxy as the proxy care-of-address. The home agent can send a confirmation of the proxy mobile IP registration to the proxy care-of-address and form a tunnel from the home network to the proxy care-of-address. The foreign agent or the proxy can forward data received via the tunnel to the communication device.

Proxy mobile IP and client mobile IP each has certain advantages. Proxy mobile IP provides better mobility within an access network over client mobile IP due to proxy mobile IP's improved handoff speed and efficiency within the access network. Also, with proxy mobile IP, tunnels from home networks end within the access network rather than extending to the communication devices. Maintaining such tunnels to the communication devices reduces the efficiency of the access network. On the other hand, client mobile IP provides relatively efficient handoffs between access networks.

### SUMMARY OF THE INVENTION

The present invention relates to a method and a system for registering a mobile communication device with an access network. The method can include receiving a request for a client mobile internet protocol (IP) registration from the mobile communication device, performing a proxy mobile IP registration on behalf of the mobile communication device, and communicating a client mobile IP registration confirmation to the mobile communication device.

The present invention also relates to a system for registering a mobile communication device with an access network. The system can include an access network component, such as a proxy, that receives a request for a client mobile internet protocol (IP) registration from the mobile communication device, performs a proxy mobile IP registration on behalf of the mobile communication device, and communicates a confirmation of the client mobile IP registration to the mobile communication device.

The present invention also relates to a program storage device readable by a machine, tangibly embodying a program of instructions executable by the machine to perform the various steps and/or functions described herein.

### BRIEF DESCRIPTION OF THE DRAWINGS

Various embodiments of the present invention will be described below in more detail, with reference to the accompanying drawings, in which:

FIG. 1 depicts a communication system that is useful for understanding the present invention;

FIG. 2 depicts a signal flow diagram that is useful for understanding the invention;

FIG. 3 depicts another signal flow diagram that is useful for understanding the invention;

FIG. 4 depicts another signal flow diagram that is useful for understanding the invention;

FIG. 5 depicts a flowchart that is useful for understanding the present invention;

FIG. 6 depicts another flowchart that is useful for understanding the present invention; and

FIG. 7 depicts another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and system that enables a mobile communication device (hereinafter “communication device”) to register and communicate with a proxy mobile IP access network in accordance with client mobile IP. Accordingly, such a communication device need not also be configured for proxy mobile IP in order to utilize the proxy mobile IP access network. Moreover, the communication device can enjoy the intra-access network handoff efficiency provided by proxy mobile IP, in which handoffs are handled by access network infrastructure, while also benefitting from the inter-access network handoff efficiency provided by client mobile IP.

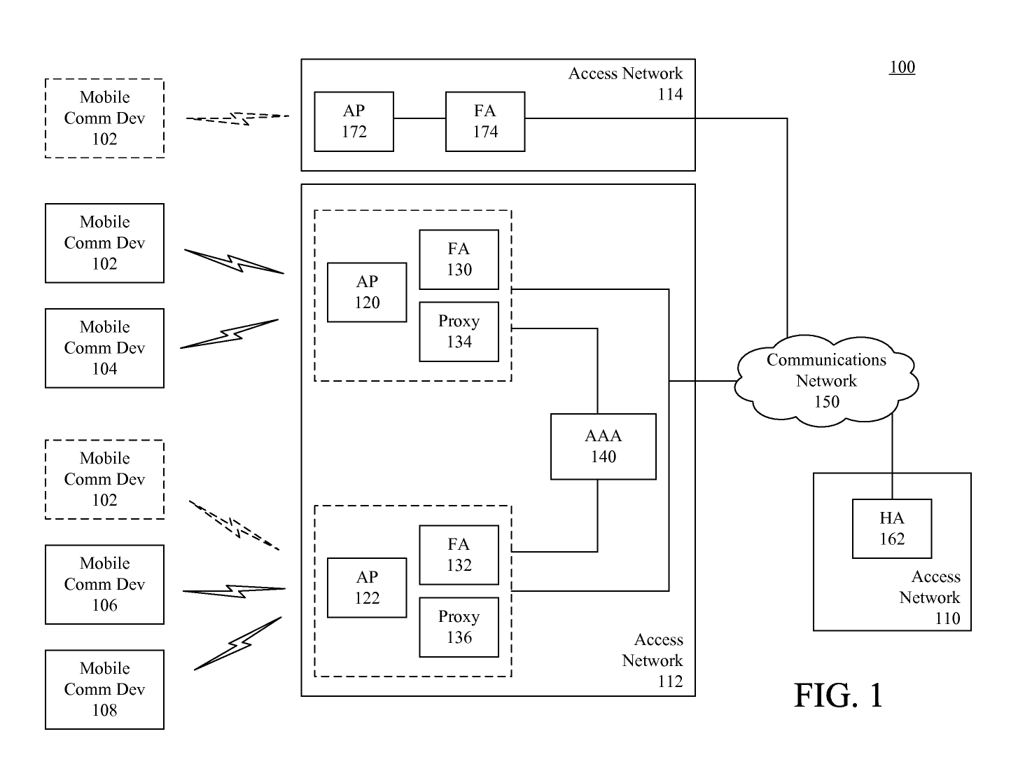

FIG. 1 depicts a communication system 100 that is useful for understanding the invention. The communication system 100 can be implemented in accordance with one or more applicable wireless communications and air interface standards. Examples of such standards can include, but are not limited to, Institute of Electrical and Electronics Engineers (IEEE) 802 wireless communications, for example, 802.11 and 802.16 (e.g. WiMAX), standards proposed by the Internet Engineering Task Force (IETF) (e.g. RFC 3344—IP Mobility Support for IPv4), the Open Mobile Alliance (OMA), the WiFi Alliance, the 3rd Generation Partnership Project (3GPP), and/or the 3rd Generation Partnership Project 2 (3GPP2) (e.g. EV-DO). The communication system 100 also can implement any of a variety of communication protocols including, but not limited to, GSM, TDMA, CDMA, WCDMA, OFDM, etc. Modifications or deviations from the standards and/or protocols can be made to suitably implement embodiments of the present invention.

In that regard, the communication system 100 can include a communications network 150 which can include any suitable network infrastructure, for example a wide area network (WAN), such as the Internet, the World Wide Web, a cellular communications network, a public switched telephone network (PSTN), and/or any other networks or systems over which communication signals can be propagated. The communications network 150 can include wired and/or wireless communication links.

The communication system 100 also can include one or more communication devices 102, 104, 106, 108. The communication devices 102-108 can be, for instance, mobile stations (e.g. mobile telephones, mobile radios, mobile computers, personal digital assistants, or the like), computers, wireless gaming devices, access terminals, subscriber stations, user equipment, or any other devices suitably configured to communicate via a wireless communications network. As such, the communication devices 102-108 can comprise one or more processors/controllers, transceivers, and/or other suitable components.

The communication system 100 further can include a plurality of access networks, for instance a first access network 110, a second access network 112, and a third access network 1 14. The access networks 110-114 can be communicatively linked via the communications network 150.

The first access network 110 can be a home access network for one or more communication devices, for instance the communication device 102. The first access network 110 can include a home agent (HA) 162 for the communication device 102. The home access network 110 also can include other components (not shown), for instance one or more access points.

The access network 112 can comprise one or more access points (AP's) 120, 122, respectively, via which the access network 112 communicates with the communication devices 102-108. The access points 120, 122, can be base transceiver stations, repeaters, or some other type of wireless transceiver. Each access point 120, 122 can be communicatively linked to a respective foreign agent (FA) 130, 132. As known to those skilled in the art, the foreign agents 130, 132 can be routers, switches or other access network components that store information about communication devices 102-108 establishing network presence on the access network 112 via the respective access points 120-122.

The access network 112 also can include respective proxies 134, 136 to which the respective access points 120, 122 may be communicatively linked. The proxies 134, 136 can request mobile IP registration on behalf of a communication device 102 when the communication device 102 connects to the access network 112 via a respective foreign agent 130, 132.

The proxies 134, 136 can be components of, or co-located with, the access points 120, 122 and/or the foreign agents 130, 132. For example, the foreign agent 130 and the proxy 134 can be provided as a single component that performs both foreign agent and proxy functions, though this need not be the case. Similarly, the foreign agent 132 and the proxy 136 can be provided as a single component. Alternatively, the proxies 134, 136 can be located elsewhere. For instance the proxies 134, 136 can be located between the respective access points 120, 122 and the foreign agents 130, 132 to which the proxies 134, 136 are communicatively linked.

The access network 112 can also include other network infrastructure, such as an authentication, authorization, and accounting (AAA) server 140, which may be communicatively linked to the foreign agents 130, 132 and proxies 134, 136. The AAA server 140 can confirm whether a communication device 102 is associated with a valid user of network resources being requested by the communication device, authorize access to network resources based on authentication of the user/communication device, and track the user's/communication device's consumption of network resources. AAA servers and their operation are well known to the skilled artisan.

The third access network 114 can include an access point 172 and a foreign agent 174. The third access network 114 also can include other components (not shown).

It is noted that in FIG. 1, the communication device 102 is shown adjacent to the access point 120 with solid lines and adjacent to access points 122, 172, with dashed lines. The dashed lines indicate that the communication device 102 moves to or from alternate positions adjacent to access points 122, 172, within the discussion presented here.

In operation, according to one arrangement, network entry of the communication device 102 to the access network 112 can be initiated in response to initialization of the communication device 102. For example, the network entry can be an initial registration of the communication device 102 via the access point 120 of the access network 1 12. According to another arrangement, network entry of the communication device 102 can be in response to an inter-network handoff of the communication device from another access network. For example, the inter-network handoff can be from the access point 172 of the access network 114 to the access point 120 of the access network 112.

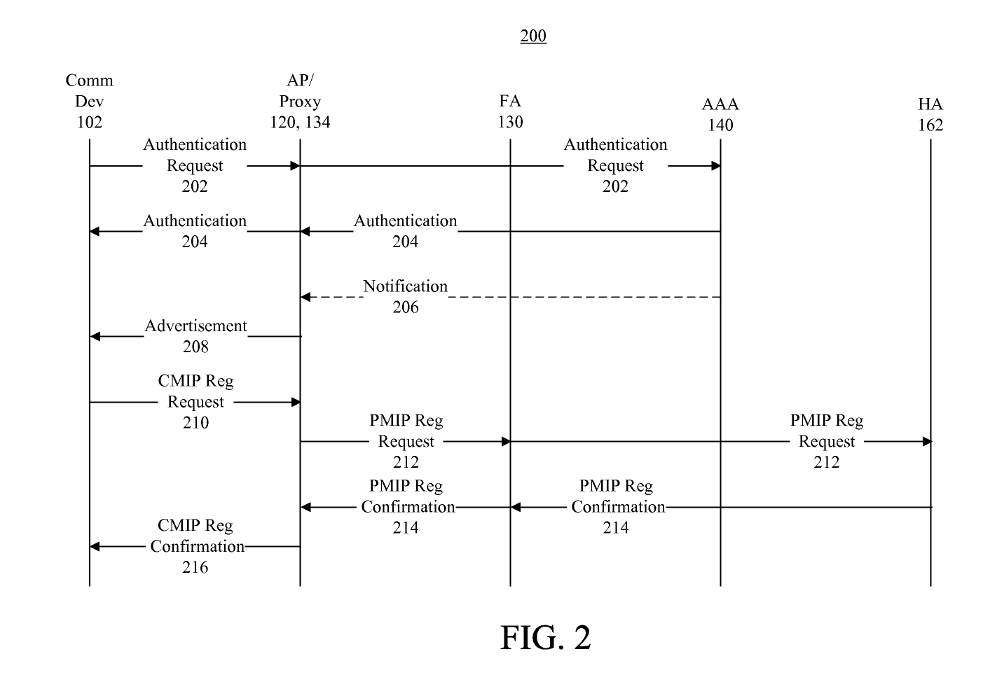

During network entry (e.g. initial registration or inter-network handoff), the communication device 102 can perform registration with the access network 112 on its own behalf. FIG. 2 is a signal flow diagram 200 that is useful for understanding network entry of the communication device 102 via the access point 120. In this signal flow diagram 200, the proxy 134 is depicted as a component of the access point 120. However, as noted, the proxy 134 can be contained elsewhere in the access network.

Upon network entry of the communication device 102 the communication device 102 can communicate an authentication request 202 to the access point 120, which can forward the authentication request 202 to the AAA server 140. In response, the AAA server 140 can communicate an authentication 204 to the communication device 102 via the access point 120. In one arrangement, the AAA server 140 also can communicate a notification 206 to the proxy 134 as part of the authentication process. The notification 206 can include information that can be used to authenticate the user of the communication device 102 with the foreign agent 130 and/or the home agent 162. An example of such information can be a shared key or other keying information. In another arrangement, the AAA server 140 need not communicate the notification 206.

The proxy 134 can communicate an advertisement 208 to the communication device 102 via the access point 120. The proxy 134 can communicate the advertisement on its own initiative or can do so in response to receiving a solicitation from the communication device 102 that requests the advertisement. The advertisement 208 can include a care-of-address (e.g. an IP address) that may be used by the communication device 102 when performing client mobile IP registration with the proxy 120 or the foreign agent 130, as will be described.

Normally, when an access network and a communication device employ client mobile IP, each communication device receives its own care-of-address. Although such an arrangement can be implemented in the present system, it is not required. Instead, the access network 112 can operate with a single distinguished care-of-address. As used herein, a “distinguished care-of-address” is a care-of-address that may be used by a plurality of communication devices that register with the access network. Accordingly, all of the communication devices communicating via the access point 120 can use the same distinguished care-of-address, thereby reducing the number of care-of-addresses that need to be maintained by the access network and reducing the overhead associated with client mobile IP registrations. This contributes to efficient operation of the access network 112. The proxy 134 or the foreign agent 130 can maintain a mapping of the various communication devices that use the distinguished care-of-address, as will be described in greater detail.

In response to the advertisement 208, the communication device 102 can initiate registration with the access network by communicating a client mobile IP registration request 210 to the proxy 134. For example, the mobile IP registration request 210 can be communicated to the proxy 134 and can include the distinguished care-of-address. The client mobile IP request 210 can identify an IP address for the home agent 162 and a home address for the communication device 102. Alternatively, the proxy 134 or the foreign agent 130 can obtain the IP address for the home agent 162 and/or the home address for the communication device 102 from the AAA server 140 or from another source. In such an arrangement, the IP address for the home agent 162 and the home address for the communication device 102 need not be included in the request communicated to the proxy 134 or the foreign agent 130, or can be set to zero in the request.

The proxy 134 need not forward the client mobile IP registration to the home agent 162. Instead, the proxy 134 can perform a proxy mobile IP registration on behalf of the communication device 102. For example, the proxy 134 can generate a proxy mobile IP registration request 212 and communicate such request to the foreign agent 130. Alternatively, the foreign agent 130 can generate the proxy mobile IP registration request 212. Regardless of which network component generates the proxy mobile IP registration request 212, such request can be forwarded to the home agent 162 on behalf of the communication device 102. In one arrangement, the proxy mobile IP registration request 212 can include the distinguished care-of-address as the proxy care-of-address. The distinguished care-of-address can be the IP address of the proxy 134 or the IP address of the foreign agent 130. The home agent 162 can use the distinguished care-of-address when forwarding communications to the communication device 102.

In response to the proxy mobile IP registration request 212, the home agent 162 can communicate to the foreign agent 130 or the proxy 134 a proxy mobile IP registration confirmation 214. For example, if the proxy mobile IP registration request 212 includes the IP address of the foreign agent 130 as a proxy care-of-address, the home agent 162 can communicate the proxy mobile IP registration confirmation 214 to the foreign agent 130. In this situation, the foreign agent 130 can perform the functions of a proxy 134. If, however, the proxy mobile IP registration request 212 includes the IP address of the proxy 134 as the proxy care-of-address, the home agent 162 can communicate the proxy mobile IP registration confirmation 214 to the proxy 134. The confirmation can include a home address (an IP address) for the communication device 102.

In response to the proxy mobile IP registration confirmation 214, the foreign agent 130 (e.g. via the access point 120) or the proxy 134 can complete client mobile IP registration of the communication device 102 by communicating a client mobile IP registration confirmation 216 to the communication device 102. The confirmation of the client mobile IP registration can include the distinguished care-of-address, the home address for communication device 102, and the IP address of the home agent 162.

Referring again to FIG. 1, pursuant to the initial registration or inter-network handoff of the communication device 102, the home agent 162 can form a secure communication channel (e.g. a tunnel) from the home network 110 to the care-of-address of the proxy 134 (e.g. the distinguished care-of-address) or a care-of address of the foreign agent 130. The proxy 134 or the foreign agent 130 can map such secure communication channel to the communication device 102. Thus, data that the home network 110 receives for the communication device 102 can be forwarded to the communication device 102 using the secure communication channel. For example, if the proxy mobile IP registration includes the IP address of the foreign agent 130 as the care-of-address, the foreign agent can receive the data and communicate the data to the communication device 102. If, however, the proxy mobile IP registration includes the IP address of the proxy 134 as the care-of-address, the proxy 134 can receive the data and communicate the data to the communication device 102.

At some point in time, the communication device 102 may move from the access point 120 to another access point, which may be referred to as a handoff. If the communication device 102 moves from access point 120 to access point 122, the handoff may be referred to as an intra-network handoff because the handoff occurs within the access network 112. If the communication device 102 moves from access point 120 to access point 172, the handoff may be referred to as an inter-network handoff since the handoff occurs between the access networks 112 and 114. Upon the inter-network handoff according to one arrangement, the access network 114 can register the communication device using client mobile IP alone. According to another arrangement, the access network 114 can register the communication device 102 using both client and proxy mobile IP. In such an arrangement, the communication device 102 can request a client mobile IP registration from the foreign agent 174 and the foreign agent 174 can perform a proxy mobile IP registration on behalf of the communication device 102. The foreign agent 174 or a proxy (not shown) can communicate a confirmation of the client mobile IP registration to the communication device 102.

The intra-network handoff of the communication device 102 from the access point 120 to the access point 122 also requires another access network registration so that the access network 112 will continue to have knowledge of the present location of the communication device 102. However, in lieu of the communication device 102 performing a new access network registration, the access network 112 can perform a proxy mobile IP registration on behalf of the communication device 102.

In one arrangement, the proxies 134, 136 can be located at the respective access points 120, 122. In such an arrangement, the access points 120, 122 can coordinate the timing of the proxy mobile IP registration with the layer 2 handoff procedure for the particular access technology. Layer 2 handoff procedures are known to the skilled artisan. In another arrangement, the proxies 134, 136 can be located elsewhere. For example, the proxies 134, 136 can be co-located with the foreign agents 130, 132. In this arrangement, signaling between the access points 120, 122 and the respective proxies 134, 136 can be used to coordinate the timing of the proxy mobile IP registration with the layer 2 handoff procedure.

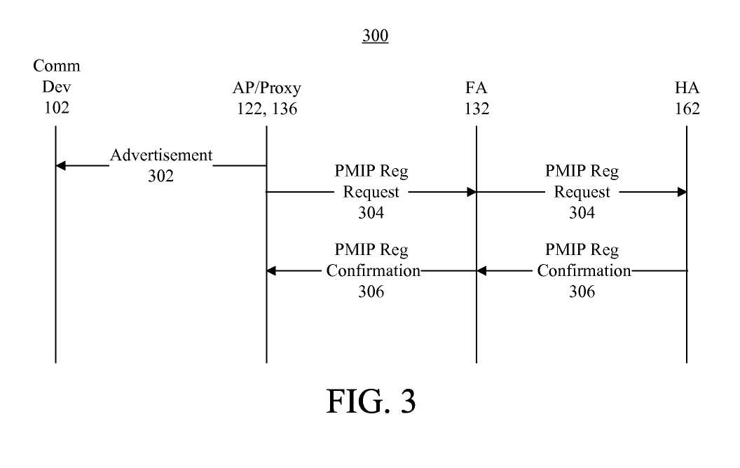

FIG. 3 is a signal flow diagram 300 that is useful for understanding intra-network handoff of the communication device 102 to the access point 122. Upon the intra-network handoff of the communication device 102 to the access point 122, the proxy 136 can communicate an advertisement 302 to the communication device 102. The advertisement 302 can contain the distinguished care-of-address that can be used by the communication device 102 as part of a communication session that employs client mobile IP.

The proxy 136 also can communicate a proxy mobile IP registration request 304 to the home agent 162 via the foreign agent 132. The proxy mobile IP registration request 304 can include a proxy care-of-address of either the foreign agent 132 or the proxy 136. If the proxy mobile IP registration request 304 includes the IP address of the foreign agent 132 as the proxy care-of-address, the home agent 162 can communicate a proxy mobile IP registration confirmation 306 to the foreign agent 132. If the proxy mobile IP registration request 306 includes the IP address of the proxy 136 as the proxy care-of-address, the home agent 162 can communicate the proxy mobile IP registration confirmation 306 to the proxy 136. Meanwhile, the communication device 102 can determine that the distinguished care-of-address is the client mobile IP address that it is already using. In such a situation, the communication device 102 can determine that it does not need to request a new client mobile IP registration.

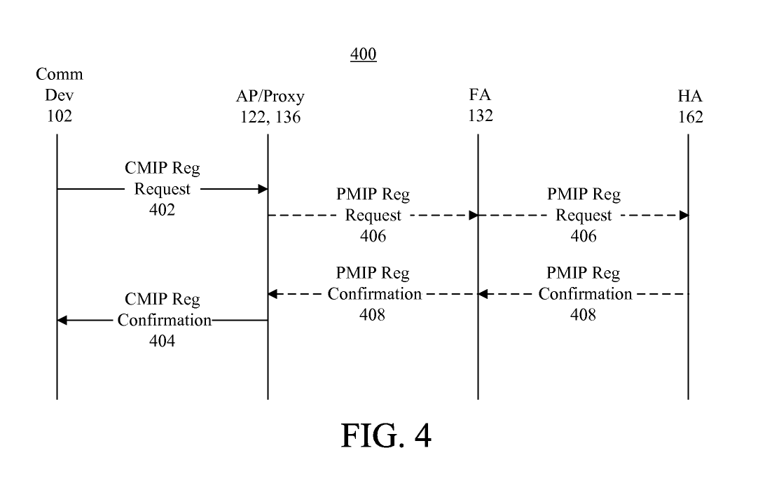

FIG. 4 is a signal flow diagram that is useful for understanding an update of a client mobile IP registration. The communication device 102 can communicate a new client mobile IP registration request 402 to the proxy 136, for example in response to the communication device 102 determining that its current client mobile IP registration is about to expire. In response, the proxy 136 can communicate a new client mobile IP registration confirmation 404 to the communication device 102. The proxy 136 also can analyze the content of the new client mobile IP registration to determine whether the proxy mobile IP registration should be updated. If so, the proxy 136 can communicate a proxy mobile IP registration update 406 to the home agent 162 via the foreign agent 132. In response, the home agent 162 can communicate a proxy mobile IP confirmation 408 to the foreign agent 132 or the proxy 136.

Again making reference to FIG. 1, it should be noted that in using client mobile IP to register the communication devices 102-108 when they first establish presence on the access network 112, and maintaining those registrations as the communication devices move among access points 120, 122 of the access network 112, the number of client mobile IP registrations performed by the access network 112 can be greatly reduced. This provides for highly efficient operation of the access network 112.

Further, by combining a client mobile IP registration and a proxy mobile IP registration for the communication device 102, the communication device 102 can benefit from the efficiency that results when handing off between the access points 120, 122 within the access network 112 using proxy mobile IP, as well as benefit from the handoff efficiency that results when handing off between the access networks 112, 114 using client mobile IP.

The access network 112 also can register a communication device that does not have client mobile IP capability. For example, a communication device 104 can attempt to register via access point 120 using simple IP by communicating a Dynamic Host Configuration Protocol (DHCP) request to the access network 112. In such a situation, the foreign agent 130, or the foreign agent 130 and the proxy 134, can perform a proxy mobile IP registration on behalf of the communication device 104. Moreover, modification of the communication device 104 is not needed. If the communication device 104 has client mobile IP capability, the access network 112 can take advantage of it. If not, the communication device 104 can be registered with a combination of simple IP and proxy mobile IP.

In an arrangement in which the proxies 134, 136 are located at the access points 120, 122, communication from the access point 120 or 122 to the communication device 102 can use client mobile IP, which can include a tunnel from the access point 120 or 122 to the communication device 102. In such an arrangement, intra-network handoffs can be coordinated by the access points 120, 122, which can include coordinating the proxy mobile IP registration and the layer 2 handoff procedure, as noted. This can improve handoff speed and can also provide more robust handoffs. Also in such an arrangement, the communication device 102 need not switch stacks when doing an inter-network handoff.

If the proxies 134, 136 are co-located with the foreign agents 130, 132, coordination between the foreign agent 130 or 132 and the respective proxy 134 or 136 can improve the speed of the combination of the client mobile IP registration and the proxy mobile IP registration. If the proxies 134, 136 are employed as distinct components rather than as components of the foreign agents 130, 132, messaging to the communication device 102 during intra-network handoffs can be reduced.

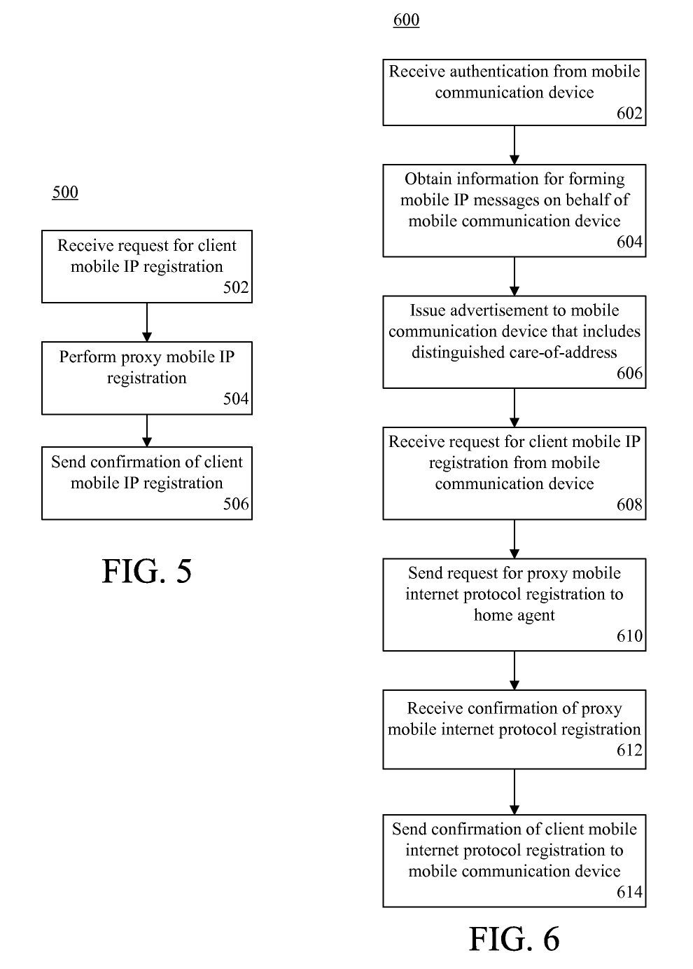

FIG. 5 depicts a flowchart that presents a method 500 that is useful for understanding the present invention. The method 500 can begin in a state in which a communication device is attempting network entry onto an access network. For example, the network entry can occur upon initiation of a communication device or an inter-network handoff of the communication device from another access network. The access network can then perform an authentication of the communication device. At step 502, a foreign agent of the access network can receive a request for a client mobile IP registration from the communication device. At step 504, the foreign agent, or the foreign agent and a proxy, can perform a proxy mobile IP registration on behalf of the communication device. Performing the proxy mobile IP registration can include requesting the proxy mobile IP registration from a home agent and receiving a confirmation of the proxy mobile IP registration from the home agent. At step 506, the foreign agent or the proxy can confirm the client mobile IP registration to the communication device.

FIG. 6 depicts a flowchart that presents a method 600 that is useful for understanding the present invention. The method 600 can begin with network entry of a communication device (e.g. upon initiation of the communication device or an inter-network handoff of the communication device from another network). At step 602, an AAA server of an access network can receive an authentication from the communication device. At step 604, a foreign agent of the access network can obtain information for forming proxy mobile IP registrations on behalf of the communication device. For example, the foreign agent can receive the information for forming the proxy mobile IP registrations from the AAA server.

At step 606, the foreign agent can communicate an advertisement to the communication device that includes a distinguished care-of-address. The foreign agent can communicate the advertisement on its own initiative or can do so in response to receiving a solicitation from the communication device. The distinguished care-of-address can be used by multiple communication devices that form wireless links with access points of the access network. These communication devices can include all of the communication devices that form wireless links with access points of the access network or a portion of such communication devices.

At step 608, the foreign agent can receive a request for a client mobile IP registration from the communication device. The request for the mobile IP registration can include the distinguished care-of-address and a home address for the communication device. Alternatively, the foreign agent can determine the home address for the communication device from the AAA server or some other source.

At step 610, the foreign agent can communicate a request for a proxy mobile IP registration to a home agent. The home agent can be located within a home network for the communication device. At step 612, the foreign agent or a proxy receives a confirmation of the proxy mobile IP registration from the home agent. For example, if the request sent to the home agent identifies the IP address for the foreign agent as a proxy care-of-address, the foreign agent can receive the confirmation of the proxy mobile IP registration from the home agent. Alternatively, if the request sent to the home agent identifies the IP address of the proxy as the proxy care-of-address, the proxy can receive the confirmation of the proxy mobile IP registration from the home agent. At step 614, the foreign agent or the proxy can communicate a confirmation of the client mobile IP registration to the communication device. As the home network receives data destined for the communication device, the home agent can forward the data to the foreign agent or the proxy via a tunnel. The foreign agent or the proxy can then forward the data to the communication device.

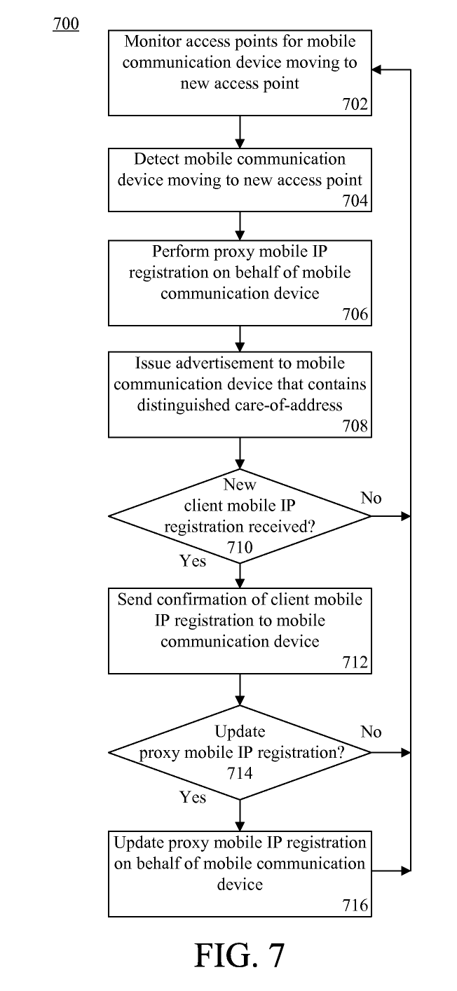

FIG. 7 depicts a flowchart that presents a method 700 that is useful for understanding the present invention. The method 700 can apply when there is an intra-network handoff of a communication device from an access point to a new access point within an access network. At step 702, the access network can monitor access points to detect the communication device moving to the new access point in the access network. At step 704, the access network can detect the mobile communication moving to the new access point. At step 706, a foreign agent, or a foreign agent and a proxy, can perform a proxy mobile IP registration on behalf of the communication device. At step 708, the foreign agent can communicate an advertisement to the communication device that includes a distinguished care-of-address that the communication device had been using while communicating with its previous access point. As noted, the distinguished care-of-address can be used by multiple communication devices communicating with access points of the access network. This could be all of the communication devices communicating with access points of the access network or some smaller group of the communication devices. Upon receiving the advertisement from the foreign agent, the communication device can determine that the distinguished care-of-address has already been registered. Consequently, the mobile communication can determine that it does not need to form a new client mobile IP registration at step 710.

Under some situations, the communication device could determine that it should form a new client mobile IP registration at step 710. For example, the communication device could determine that the client mobile IP registration is about to expire. If so, the mobile communication can communicate a request for a client mobile IP registration to the foreign agent that includes the distinguished care-of-address. At step 712, the foreign agent can communicate a confirmation of the client mobile IP registration to the communication device. At step 714, the foreign agent could determine that the proxy mobile IP registration should be updated upon receiving the request. If so, the foreign agent or the foreign agent and the proxy can update the proxy mobile IP registration on behalf of the communication device at step 716.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. For example, the present invention can be implemented by modifying foreign agents or foreign agents and proxies. Generally, these modifications can be accomplished through software changes, but may also be accomplished by hardware changes or a combination of hardware and software changes.

The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A method of registering a mobile communication device with an access network, comprising:
receiving a request for a client mobile internet protocol (IP) registration from the mobile communication device;
performing a proxy mobile IP registration on behalf of the mobile communication device; and
communicating a client mobile IP registration confirmation to the mobile communication device.

2. The method of claim 1, wherein performing the proxy mobile IP registration on behalf of the mobile communication device comprises:
communicating a request for a proxy mobile IP registration to a home agent of the mobile communication device; and
receiving a confirmation of the proxy mobile IP registration from the home agent.

3. The method of claim 2, wherein communicating the request for the proxy mobile IP registration comprises communicating the proxy mobile IP registration to the home agent via a foreign agent.

4. The method of claim 1, further comprising:
communicating an advertisement comprising a distinguished care-of-address to the mobile communication device;
wherein receiving the request for the client mobile IP registration comprises receiving a request that comprises the distinguished care-of-address.

5. The method of claim 4, further comprising:
communicating at least a second advertisement comprising the distinguished care-of-address to at least a second mobile communication device; and
receiving a request for a client mobile IP registration from the second communication device, the request comprising the distinguished care-of-address.

6. The method of claim 1, further comprising performing a new proxy mobile IP registration in response to the mobile communication handing off from a first access point of the access network to a second access point of the access network.

7. The method of claim 1, wherein receiving the request for the client mobile IP registration from the communication device comprises receiving the client mobile IP registration request during initial registration of the mobile communication device with the access network.

8. The method of claim 1, wherein receiving the request for the client mobile IP registration from the communication device comprises receiving the client mobile IP registration request during an inter-network handoff of the mobile communication device from a second access network.

9. The method of claim 1, further comprising:
receiving an authentication for the mobile communication device from an authentication, authorization, and accounting server; and
forwarding the authentication to the mobile communication device.

10. The method of claim 1, further comprising:
receiving a notification from a server, the notification including information for preparing mobile IP messages on behalf of the mobile communication device.

11. A system for registering a mobile communication device with an access network, comprising:
a proxy that receives a request for a client mobile internet protocol (IP) registration from the mobile communication device, performs a proxy mobile IP registration on behalf of the mobile communication device, and communicates a confirmation of the client mobile IP registration to the mobile communication device.

12. The system of claim 11, wherein the proxy communicates a request for the proxy mobile IP registration to a home agent of the mobile communication device and receives a confirmation of the proxy mobile IP registration from the home agent.

13. The system of claim 12, further comprising a foreign agent, wherein the proxy communicates the request to the home agent via the foreign agent.

14. The system of claim 11, wherein:
the proxy communicates an advertisement to the mobile communication device comprising a distinguished care-of-address that is an IP address of the proxy; and
the client mobile IP registration comprises the distinguished care-of-address.

15. The system of claim 14, wherein:
the proxy communicates an advertisement comprising the distinguished care-of-address to at least a second mobile communication device; and
the proxy receives at least a second client mobile IP registration from the second mobile communication device, the second client mobile IP registration comprising the distinguished care-of-address.

16. The system of claim 11, further comprising a second proxy that performs a new proxy mobile IP registration in response to the mobile communication handing off from a first access point of the access network to a second access point of the access network.

17. The system of claim 11, wherein the proxy receives the client mobile IP registration request during initial registration of the mobile communication device with the access network.

18. The system of claim 11, wherein the proxy receives the client mobile IP registration request during an inter-network handoff of the mobile communication device from a second access network.

19. The system of claim 11, wherein the proxy receives a notification from a server, the notification including information for preparing mobile IP messages on behalf of the mobile communication device.

20. A program storage device readable by a machine, tangibly embodying a program of instructions executable by the machine to perform method steps for registering a mobile communication device with an access network, said method steps comprising:
receiving a request for a client mobile internet protocol (IP) registration from the mobile communication device;
performing a proxy mobile IP registration on behalf of the mobile communication device; and
communicating a client mobile IP registration confirmation to the mobile communication device.
